(19) United States
(12) Patent Application Publication
(10) Pub. No.: US 2008/0130312 A1
(43) Pub. Date: Jun. 5, 2008

(54) BACKLIGHT MODULE

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/833,239

(22) Filed: Aug. 3, 2007

(30) Foreign Application Priority Data
Dec. 1, 2006 (CN) 200610201175.4

(51) Int. Cl. F21V 8/00; F21V 7/00

(52) U.S. Cl. 362/607; 362/606; 362/617

(57) ABSTRACT

A backlight module includes a housing, a light source, and a light guide plate. The housing includes a bottom wall, a side wall extending perpendicularly from edges of the bottom wall, and a reflecting film formed on an inner surface of the bottom wall. The housing accommodates the light source and the light guide plate. The light guide plate receives light beams from the light source, and diffuses the light beams to emit from an upper surface of the light guide plate. The reflecting film reflects the light beams, which leak from a bottom surface of the light guide plate, to emit from the upper surface of the light guide plate.

### BACKGROUND

1. Field of the Invention

The present invention relates to backlight modules, and particularly to backlight modules for use in light display devices such as liquid crystal displays.

2. Description of Related Art

In a liquid crystal display device, liquid crystal is a substance that does not itself radiate light. Instead, the liquid crystal relies on receiving light from a light source, thereby displaying images and data. In the case of a typical liquid crystal display device, a backlight module powered by electricity supplies the needed light.

Backlight modules generally include edge-lighting type backlight modules and direct type backlight modules. Referring to FIG. 2, a conventional edge-lighting type backlight module includes a housing 700 accommodating a light source 100, a reflector 200, a light guide plate 300, a diffusion plate 400, and two brightness enhancement plates 500, 600. The light guide plate 300 is configured for receiving light beams from the light source 100, and for diffusing the light beams to emit from an upper surface of light guide plate 300. The reflector 200, positioned below the light guide plate 300, includes a base plate 210 and a reflecting film 220 formed on the base plate 210. The reflector 200 reflects the light beams, which leak from a bottom surface of the light guide plate 300, to emit from the upper surface of the light guide plate 300. The diffusion plate 400 is disposed on the light guide plate 300 to provide greater light uniformity. The brightness enhancement plates 500, 600 are disposed on the diffusion plate 400 sequentially to enhance brightness of the light. The base plate 210 is made of acrylic material. The reflecting film 220 is made of aluminum material. In assembly, the reflecting film 220 is deposited on the base plate 210 to assemble the reflector 200. Then the reflector 200 is deposited on a bottom wall of the housing 700. Assembly of the backlight module is thus time-consuming.

What is needed, therefore, is a backlight module with a timesaving assembly.

### SUMMARY

A thin backlight module with a timesaving assembly is provided. In an embodiment, the backlight module includes a housing, a light source, and a light guide plate. The housing includes a bottom wall, a side wall extending perpendicularly from edges of the bottom wall to form a box shape, and a reflecting film formed on an inner surface of the bottom wall. The housing accommodates the light source and the light guide plate. The light guide plate receives light beams from the light source, and diffuses the light beams to emit from an upper surface of the light guide plate. The reflecting film reflects the light beams, which leak from a bottom surface of the light guide plate, to emit from the upper surface of the light guide plate.

Other advantages and novel features will become more apparent from the following detailed description when taken in conjunction with the accompanying drawings, in which:

### BRIEF DESCRIPTION OF THE DRAWINGS

FIG. 1 is a schematic, front view of a backlight module in accordance with an embodiment of the present invention; and

FIG. 2 is a schematic, front view of a conventional backlight module.

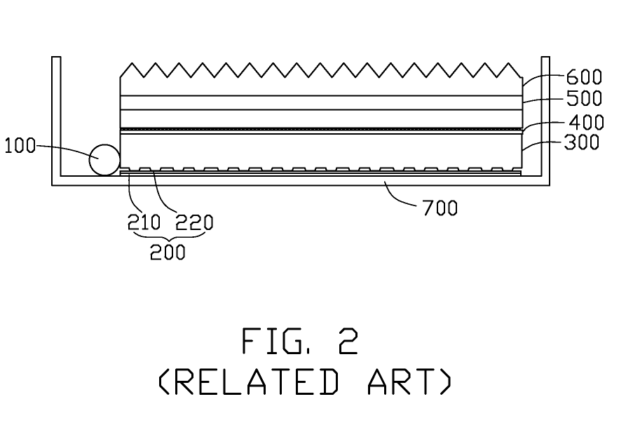

### DETAILED DESCRIPTION OF THE INVENTION

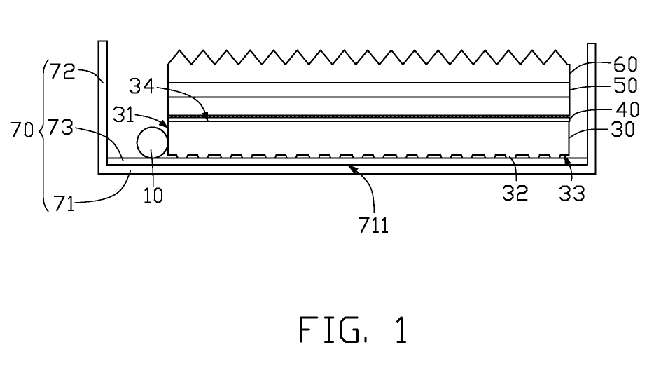

Referring to FIG. 1, a backlight module in accordance with an embodiment of the present invention includes a housing 70 accommodating a light source 10, a light guide plate 30, a diffusion plate 40, and two brightness enhancement plates 50, 60.

The housing 70 includes a bottom wall 71, a side wall 72 extending perpendicularly from edges of the bottom wall 71 to form a box shape, and a reflecting film 73 plated on an inner surface 711 of the bottom wall 71 with a chemical process. The reflecting film 73 is made of silver or aluminum material with good light reflecting characteristics. The light guide plate 30 and the light source 10 are positioned side-by-side on the reflecting film 73. The light source 10 used in the backlight module can be a light emitting diode (LED), or a cold cathode fluorescent lamp (CCFL). The light guide plate 30 includes a plurality of similar shaped protrusions 32 formed on a bottom surface 33 thereof, which is perpendicular to a side surface 31 beside which the light source 10 is disposed.

The plurality of similar shaped protrusions 32 diffuse the light beams from the light source 10 to emit from an upper surface 34 of the light guide plate 30, which is opposite to the bottom surface 33. The reflecting film 73 reflects the light beams, which leak from the bottom surface 33, to emit from the upper surface 34 of the light guide plate 30. The diffusion plate 40 is disposed on the light guide plate 30 to enhance uniform distribution of the light beams. The brightness enhancement plates 50, 60 are disposed on the diffusion plate 40 sequentially to enhance brightness of the light beams.

The reflecting film 73 is directly formed on the inner surface 711 of the housing 70 when the housing 70 is manufactured. The base plate of the conventional art is omitted thus saving on time and material. Therefore, the assembly of the present backlight module is less costly compared to the conventional art.

The embodiment was chosen and described in order to explain the principles of the invention and their practical application so as to enable others skilled in the art to utilize the invention and various embodiments and with various modifications as are suited to the particular use contemformed. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A backlight module configured to uniformly illuminate a liquid crystal panel, comprising:
a housing comprising a single bottom wall, a side wall extending perpendicularly from edges of the bottom wall, and a reflecting film formed on an inner surface of the bottom wall; and
a light source and a light guide plate being accommodated in the housing, wherein the light guide plate is disposed on the reflecting film configured to receive light beams from the light source, and diffuse the light beams to emit from an upper surface of the light guide plate, the reflecting film is configured to reflect the light beams, which leak from a bottom surface of the light guide plate, to emit from the upper surface of the light guide plate.

2. The backlight module as claimed in claim 1, further comprising a diffusion plate disposed on the light guide plate and accommodated in the housing, for enhancing uniform distribution of the light beams.

3. The backlight module as claimed in claim 2, further comprising a light brightness enhancement plate disposed on the diffusion plate and accommodated in the housing.

4. The backlight module as claimed in claim 1, wherein the reflecting film is made of silver or aluminum material with good light reflecting characteristics.

5. A backlight module configured to uniformly illuminate a liquid crystal panel, comprising:
a light source;
a light guide plate having a side surface adjacent the light source for entry of light beams from the light source, a bottom surface perpendicular to the side surface, a plurality of protrusions formed on the bottom surface, and an upper surface opposite to the bottom surface; and
a housing for accommodating the light source and the light guide plate therein, the housing comprising a bottom wall, a reflecting film formed on an inner surface of the bottom wall, wherein the protrusions diffuse the light beams from the light source to emit from the upper surface of the light guide plate, the reflecting film reflects the light beams, which leak from the bottom surface of the light guide plate, to emit from the upper surface of the light guide plate.

6. The backlight module as claimed in claim 5, further comprising a diffusion plate disposed on the light guide plate and accommodated by the housing, for enhancing uniform distribution of the light beams.

7. The backlight module as claimed in claim 6, further comprising a light brightness enhancement plate disposed on the diffusion plate and accommodated by the housing.

8. The backlight module as claimed in claim 5, wherein the reflecting film is made of silver or aluminum material with good light reflecting characteristics.

9. The backlight module as claimed in claim 5, wherein the light source is disposed on the reflecting film directly.

10. A backlight module configured to illuminate a light display device, comprising:
a housing comprising a single bottom wall, a side wall extending perpendicularly from edges of the bottom wall;
a light source disposed in the housing;
a light guide plate having a side surface adjacent the light source for entry of light beams from the light source, a bottom surface perpendicular to the side surface, and an upper surface opposite to the bottom surface, a plurality of protrusions formed on the bottom surface configured to diffuse the light beams from the light source to emit from the upper surface of the light guide plate; and
a reflecting film plated on an inner surface of the bottom wall of the housing configured to reflect the light beams, which leak from the bottom surface of the light guide plate, to emit from the upper surface of the light guide plate.

11. The backlight module as claimed in claim 10, wherein the light source is disposed on the reflecting film directly.
